(19) United States
(12) Patent Application Publication
(10) Pub. No.: US 2009/0205945 A1
(43) Pub. Date: Aug. 20, 2009

(54) Process and apparatus for alkylation of benzene with aliphatic mono-olefin compound

(76) Inventors: Stephen W. Sohn, Arlington Heights, IL (US); Bryan K. Glover, Algonquin, IL (US); Andrea G. Bozzano, Des Plaines, IL (US)

Correspondence Address: HONEYWELL/UOP;PATENT SERVICES, 101 COLUMBIA DRIVE, P O BOX 2245 MAIL STOP AB/2B, MORRISTOWN, NJ, 07962, US

(21) Appl. No.: 11/042,700

(22) Filed: Jan. 25, 2005

(51) Int. Cl. B01D 3/06; B01D 3/34; B01D 3/42

(52) U.S. Cl. 203/38; 202/161; 202/160; 202/154

(57) ABSTRACT

Processes and apparatus for the alkylation of benzene with mono-olefin aliphatic compound in at least two reaction zones in the presence of solid alkylation catalyst use a crude distillation of the reaction effluent passing between reaction zones to remove a substantial portion of the alkylbenzene. The processes reduce the amount of heavies generated in an economically attractive manner.

### FIELD OF THE INVENTION

This invention relates to economically attractive processes and apparatus for the alkylation of benzene with mono-olefin aliphatic compound to provide an alkylbenzene reaction product having reduced heavies.

### BACKGROUND TO THE INVENTION

Alkylation of benzene produces alkylbenzenes that may find various commercial uses, e.g., alkylbenzenes can be sulfonated to produce detergents. In the alkylation process, benzene is reacted with an olefin the desired length to produce the sought alkylbenzene. The alkylation conditions comprise a catalyst such as aluminum chloride, hydrogen fluoride, or zeolitic catalysts and elevated temperature.

The alkylation, however, is not selective and can produce dimers, dialklaryl compounds and diaryl compounds and can affect skeletal isomerization of the olefin, resulting in a loss of selectivity to the sought alkylbenzene. These dimers, dialkylaryl compounds and diaryl compounds are herein referred to as heavies. The formation of dialkylaryl compounds is particularly problematic as the reaction approaches complete conversion of the olefin and the concentration of the alkylbenzene has thus increased thereby increasing the likelihood that an olefin molecule will react with an alkylbenzene molecule rather than benzene. Accordingly, typical processes use a large excess of benzene to reduce the molar ratio of the sought alkylbenzene to the olefin in the reactor. In many instances, the mole ratio of benzene to olefin is greater than 15:1.

A number of proposals have been made to achieve some of the benefits of high benzene to olefin feed ratios without having to incur the costs associated with using such excesses of benzene. For instance, the use of more than one reaction zone with the olefin-containing feed being introduced into each of the reactors is often done. This process has the advantage of being inexpensive from a capital and operating cost standpoint. Others have proposed processes to further improve selectivity without further increasing the molar ratio of benzene to olefins. U.S. Pat. No. 5,777,187 discloses the use of reactive distillation where a feed mixture of benzene and the olefin is passed into a column containing catalyst. Two problems exist with this approach. First, the capital and operating expense are increased. Second, as the catalyst needs to be regenerated or replaced, the entire reactive distillation column needs to be shut down.

Another potential is to have a multistage reactor with product separation by distillation between the stages with the benzene and unreacted olefin passed to the subsequent reactor. However, such a process would not be practical due to the increased capital and operating costs associated with inter-stage fractionation. For example, benzene columns for removal of benzene from alkylbenzene reaction product often have at least 20 theoretical distillation plates. The refining system for alkylbenzene production is summarized in Pujado, Linear Alkylbenzene (LAB) Manufacture, Handbook of Petroleum Refining Processes, Second Edition, pp 1.53 to 1.66 (1996), especially pages 1.56 to 1.60. Especially for large-scale, commercial alkylation processes such as are used for the production of linear alkylbenzenes, capital and operating costs can be very important, and the addition of additional distillation steps can thus be undesirable.

Accordingly processes and apparatus are sought to reduce the production of heavies in making alkylbenzene without undue complexity or capital or operating costs.

### SUMMARY OF THE INVENTION

In accordance with this invention, energy efficient processes and apparatus for the alkylation of benzene with aliphatic olefin are provided that are capable of providing the sought alkylbenzene with reduced coproduction of heavies and without undue capital expense. The processes and apparatus of the invention use two or more alkylation reaction zones in series wherein at least a portion of the effluent from a reactor zone (upstream reaction zone) is subjected to distillation to remove alkylbenzene in a bottoms stream and wherein additional aliphatic olefin and the overhead from the distillation, which contains benzene, are passed to a subsequent alkylation reaction zone (downstream reaction zone). By reacting at least about 95 mole percent of the aliphatic olefin fed to the upstream reaction zone, the processes and apparatus of this invention can use a crude distillation to separate alkylbenzene in a bottoms stream and an overhead containing benzene while still providing an economically attractive process. With the removal of a portion of the alkylbenzene from the effluent of the upstream reaction zone, the concentration of alkylbenzene in the downstream reaction zone is decreased, thereby reducing the formation of heavies.

The crude distillation can be effected with relatively small distillation equipment and without undue energy consumption. For instance, it has been found that adequate separation can be achieved with a distillation using less than about 5, preferably less than about 2 or 3, theoretical distillation plates and an external reflux to feed ratio (R:F) of less than about 0.8. Indeed, a flash distillation is often adequate for the practice of the processes of this invention. However, such a crude distillation will not be able to recover in the overhead all the unreacted olefin and benzene, and thus the bottoms stream will contain benzene and unreacted olefin.

The broad aspects of the processes of this invention for the alkylation of benzene with aliphatic olefin of 8 to 19 carbon atoms comprise:
a. co-currently passing a mixture of benzene and said olefin to an upstream alkylation zone comprising solid alkylation catalyst under liquid phase alkylation conditions to produce an upstream effluent comprising alkylbenzene wherein at least about 95, preferably at least about 98, mole percent of the olefin passed to the upstream reaction zone is reacted therein, the mole ratio of benzene to olefin being at least about 6:1, preferably at least about 15:1;
b. distilling a distillation feed comprising at least a portion, often between about 20 and 100 weight percent, of the upstream effluent to provide at least an overhead and a bottoms stream, said overhead comprising between about 20 and 98, frequently between about 50 and 95, weight percent of benzene contained in the distillation feed, and said bottoms stream comprising at least about 80, preferably at least about 90, weight percent of the alkylbenzene contained in the distillation feed, and
c. passing the overhead from step b and additional aliphatic olefin to at least one downstream alkylation zone comprising solid alkylation catalyst, said zone being under liquid phase alkylation conditions to produce a downstream effluent comprising alkylbenzene.

Preferably the bottoms stream from step b and the downstream effluent are distilled in a second distillation zone to provide an overhead comprising benzene and a bottoms stream comprising alkylbenzene and less than 50 parts per million by weight benzene.

In more preferred aspects of the processes of this invention, distillation of step b is at a lower pressure than the upstream alkylation zone, and is often at between about 80 and 250 kPa absolute. Advantageously the pressure for step b is sufficiently lower than that of the upstream effluent that a significant portion, preferably at least about 50 percent, of the benzene in the distillation feed is vaporized. Preferably if additional heat needs to be provided to the distillation of step b to effect the sought operation, the heat provided is less than about 40, more preferably less than about 30, kilocalories per kilogram of distillation feed. The distillation of step b may be a flash separator, but preferably, in any event, less than about 5, preferably less than about 2 or 3, theoretical distillation plates are used in the distillation.

In the broad aspects of the apparatus of this invention for alkylation of aromatic compound with olefin-containing aliphatic compound, the apparatus comprises:
a. an upstream alkylation reactor having an inlet portion in fluid communication with a supply of aliphatic olefin and a supply of benzene and an outlet portion, said reactor having a chamber containing solid alkylation catalyst such that fluid passing between the inlet portion and the outlet portion contacts the catalyst, said catalyst being in an amount sufficient to react at least 95 mole percent of the olefin supplied thereto;
b. a first distillation column having an inlet in fluid communication with the outlet of the reactor, an overhead outlet, and a bottoms stream outlet, said first distillation column having less than 5, preferably less than 2 or 3, theoretical distillation plates; and
c. a downstream alkylation reactor having an inlet portion in fluid communication with a supply of aliphatic olefin and with the overhead outlet of the first distillation column and an outlet portion.

In preferred embodiments of the apparatus, the first distillation column is a flash distillation column. Preferably, a second distillation column is provided in the apparatus of the invention which has an inlet in fluid communication with the bottoms stream outlet of the first distillation column and the outlet portion of the downstream alkylation reactor.

### BRIEF DESCRIPTION OF THE DRAWINGS

FIG. 1 is a schematic representation of an apparatus adapted to practice a process in accordance with this invention.

FIG. 2 is a schematic representation of another apparatus adapted to practice a process in accordance with this invention.

FIG. 3 is a schematic representation of yet another apparatus adapted to practice a process in accordance with this invention.

FIG. 4 is a schematic representation of a segment of a benzene column in which a flash distillation is integrally incorporated to practice a process in accordance with this invention.

### DETAILED DISCUSSION

### The Feed and Products:

The aliphatic olefin used in the processes of this invention is preferably of about 8 to 19, often 9 to 16, carbon atoms. The aliphatic olefins are preferably mono-olefinic. The positioning of the olefinic bond in the molecule is not critical as most alkylation catalysts have been found to promote migration of the olefinic bond. However, the branching of the hydrocarbon backbone is often more of a concern as the structural configuration of the alkyl group on the alkylbenzene product can affect performance. For instance, where alkylbenzenes are sulfonated to produce surfactants, undue branching can adversely affect the biodegradability of the surfactant. On the other hand, some branching may be desired such as the lightly branched modified alkylbenzenes such as described in U.S. Pat. No. 6,187,981. The olefin may be unbranched or lightly branched, which as used herein, refers to an olefin having three or four primary carbon atoms and for which none of the remaining carbon atoms are quaternary carbon atoms. A primary carbon atom is a carbon atom which, although perhaps bonded also to other atoms besides carbon, is bonded to only one carbon atom. A quaternary carbon atom is a carbon atom that is bonded to four other carbon atoms.

The aliphatic olefin is usually a mixture of two or more olefins. For commercial processes, other components may be present with the olefin-containing aliphatic compound. For instance, the olefin may be obtained by the dehydrogenation of a paraffinic feedstock and unreacted paraffin, which is difficult to separate from the olefin, is passed to the alkylation reactor. See, for instance, U.S. Pat. No. 6,670,516, herein incorporated by reference. Generally, where olefin is obtained by the dehydrogenation of a paraffinic feedstock, the molar ratio of olefin to paraffin is between about 1:12 to 1:8; however, such amounts of paraffin are not critical to the processes of this invention. Indeed, olefin-containing feedstocks having an essential absence of paraffins are suitable.

The source of the paraffinic feedstock for dehydrogenation is not critical although certain sources of paraffinic feedstocks will likely result in the impurities being present. Conventionally, kerosene fractions produced in petroleum refineries either by crude oil fractionation or by conversion processes therefore form suitable feed mixture precursors. Fractions recovered from crude oil by fractionation will typically require hydrotreating for removal of sulfur and/or nitrogen prior to being fed to the subject process. The boiling point range of the kerosene fraction can be adjusted by prefractionation to adjust the carbon number range of the paraffins. In an extreme case the boiling point range can be limited such that only paraffins of a single carbon number predominate. Kerosene fractions contain a very large number of different hydrocarbons and the feed mixture to the subject process can therefore contain 200 or more different compounds.

The paraffinic feedstock may alternatively be at least in part derived from oligomerization or alkylation reactions. Such feed mixture preparation methods are inherently imprecise and produce a mixture of compounds. The feed mixtures to the process may contain quantities of paraffins having multiple branches and paraffins having multiple carbon atoms in the branches, cycloparaffins, branched cycloparaffins, or other compounds having boiling points relatively close to the desired compound isomer. Thus, the feed mixtures to the process of this invention can also contain sizable quantities of aromatic hydrocarbons.

Another source of paraffins is in condensate from gas wells. Usually insufficient quantities of such condensate are available to be the exclusive source of paraffinic feedstock. However, its use to supplement other paraffinic feedstocks can be desirable. Typically these condensates contain sulfur compounds, which have restricted their use in the past. As this invention enables the use of sulfur-containing feeds, these condensates can be used to supply paraffins for alkylation.

Paraffins may also be produced from synthesis gas (Syngas), hydrogen and carbon monoxide. This process is generally referred to as the Fischer-Tropsch process. Syngas may be made from various raw materials including natural gas and coal, thus making it an attractive source of paraffinic feedstock where petroleum distillates are not available.

The aliphatic olefin to the alkylation reactor should be sufficiently free of impurities, such as water, nitrogen compounds and sulfur compounds, that can unduly adversely affect the life of the alkylation catalyst.

### Alkylation:

The aliphatic olefin is reacted with benzene to produce alkylbenzene. Usually benzene is present in a significant stoichiometric excess to the olefin , e.g., from about 6:1 up to about 50:1 and normally from about 10:1 or 15:1 to about 30:1, on a molar basis.

Benzene and the olefin are reacted under alkylation conditions in the presence of a solid alkylation catalyst. These alkylation conditions generally include a temperature in the range between about 80° C. and about 200° C., most usually at a temperature not exceeding about 175° C., e.g., 125° C. to 160° C. Since the alkylation is typically conducted in the presence of a liquid phase, and preferably in either an all-liquid phase or at supercritical conditions, pressures must be sufficient to maintain reactants in the liquid phase. The requisite pressure necessarily depends upon the olefin and temperature, but normally is in the range of about 1300 to 7000 kPa(g), and most usually between about 2000 and 3500 kPa(g). Preferably the alkylation conditions do not substantially result in skeletal isomerization of the olefin. For instance, less than 15 mole percent, and preferably less than 10 mole percent, of the olefin, the aliphatic alkyl chain, and any reaction intermediate undergoes skeletal isomerization.

Alkylation of benzene by the olefins is conducted in a continuous manner using two or more catalyst beds in flow series. For purposes herein, a catalyst bed is termed a reactor whether in the same or a separate vessel from another bed. Each reactor has an inlet portion and an outlet portion. The reactants may be in admixture prior to entering the inlet portion of the reactor, or they may be individually introduced and mixed in the reactor.

The catalyst may be used as a packed bed, a moving bed or a fluidized bed. The feed to the reaction zone may be passed either upflow or downflow, or even horizontally as in a radial bed reactor; however, the flows of the benzene and olefin are co-current. In one desirable variant, olefin may be fed into several discrete points within the reaction zone, and at each zone the benzene to olefin molar ratio may be greater than 50:1. The total feed mixture, that is, benzene plus olefin, is often passed through the packed bed at a liquid hourly space velocity (LHSV) between about 0.3 and about 6 or 10 hr-1 depending upon, e.g., alkylation temperature and the activity of the catalyst. Lower values of LHSV within this range are preferred. It is usually desired that sufficient residence time in the reaction zone be used such that at least about 95, preferably at least about 98, and often at least about 99.5, mole percent of the olefin fed to a reaction zone is reacted in that reaction zone.

Any suitable alkylation catalyst may be used in the present invention, provided that the requirements for conversion, selectivity, and activity are met. Preferred alkylation catalysts comprise zeolites having a zeolite structure type selected from the group consisting of BEA, MOR, MTW, and NES. Such zeolites include mordenite, ZSM4, ZSM-12, ZSM-20, offretite, gmelinite, beta, NU-87, and gottardite. Clays and amorphous catalysts including silica-alumina and fluorided silica-alumina may also find utility. Further discussion of alkylation catalysts can be found in U.S. Pat. Nos. 5,196,574; 6,315,964 and 6,617,481.

### The Crude Inter-Reaction Zone Distillation:

In accordance with this invention at least a portion of an upstream alkylation reactor effluent is subjected to a crude distillation to recover as overhead a fraction of benzene fed to the crude distillation. The recovered benzene is passed to a subsequent, or downstream, alkylation reactor. The crude distillation removes a substantial portion of the alkylbenzene in the bottoms stream. Thus, the use of the crude distillation reduces the concentration of alkylbenzene passing to the downstream reactor and thus minimizes production of heavies.

The amount of the effluent from the upstream reaction zone directed to the crude distillation may be as little as 20 weight percent or may comprise the entire effluent stream. Often at least about 50, and sometimes at least about 80, weight percent of the effluent from the upstream reaction zone is subjected to the crude distillation. Where only a portion of the effluent from the upstream reaction zone is subjected to the crude distillation, the remaining portion of the effluent is preferably fed to the subsequent reactor. Preferably at least the effluent from the first reaction zone is subjected to the crude distillation with the overhead from the crude distillation being passed to the inlet portion of the immediately subsequent reaction zone.

The crude distillation is intended to only recover in the overhead a portion of the benzene fed to the crude distillation zone. The amount of benzene recovered in the overhead is often between about 20 and 98 mole percent of that fed to the crude distillation zone. Advantageously, the distillation equipment need not be extensive to effect such recovery, e.g., the distillation may be accomplished with less than about 5 theoretical distillation plates. Moreover, the crude distillation is preferably conducted without significant reboiler heat, and indeed, in some instances, the sought recovery of benzene and removal of alkylbenzene may be accomplished by a flash distillation due to a pressure drop of the effluent from alkylation reaction conditions without the need for an external heat source. The feed to the crude distillation zone may be at any convenient temperature. For instance, it may be at or close to the temperature of the effluent from the upstream alkylation reaction zone, or it may be heated or cooled by indirect heat exchange. Generally the temperature of this feed is below about 300° C., say 100° to 275° C. Where heat is desirably supplied to the lights distillation zone, e.g., to provide for internal reflux in a fractionation column, it preferably is less than about 40, more preferably less than about 30, kilocalories per kilogram of the feed to the crude distillation.

The bottoms temperature of the crude distillation zone is usually in the range of about 80° C. to 150° C., preferably between about 90° C. and 140° C., and the pressure in the crude distillation zone is typically between about 70 and 300, preferably between about 90 and 250, say, 100 and 200, kPa absolute. Where a reflux is used, the rate of external reflux (R:F) is preferably between about 0.1:1 to 5:1, more preferably between about 0.4:1 and 0.8:1, kilogram per kilogram of feed to the crude distillation zone.

The crude distillation may be effected in an open vessel for a flash distillation or may contain suitable trays or packing for a fractionation, preferably sieve trays or structured packing. Heat to the crude distillation zone may be provided by indirect heat exchange at the bottom of the zone, or by withdrawing, heating and recycling to the base of the column a portion of the liquid contained at the bottom of the crude distillation zone. Alternatively or additionally, the feed to the crude distillation zone may be heated, but preferably not to a temperature that may cause undue reaction or degradation of the alkylbenzene contained in the effluent.

The composition of the overhead from the crude distillation is primarily dependent upon the composition of the feed to the crude distillation, the temperature and pressure for the crude distillation, the reflux ratio and the practical distillation plates contained in the crude distillation zone. The practical distillation plates are determined from the actual performance of the distillation column. Usually the overhead contains less than about 99, generally between about 60 or 75 and 98, weight percent benzene fed to the crude distillation zone. The overhead may also contain alkylbenzene, unreacted olefin, by-products and paraffins, especially where the olefin is supplied in combination with paraffins of the same or similar boiling range or carbon number range. Normally where paraffins are present, less than about 60, preferably less than about 40, and often between about 5 and 30, weight percent of the paraffins in the effluent fed to the crude distillation zone is contained in the overhead. Thus the downstream reactor will have a lesser paraffins concentration than if the entire effluent from the upstream reactor were passed to the downstream reactor. Consequently, some of the diluting effect of paraffins in the second reactor will be lost. However, as a substantial portion of the alkylbenzene is removed in the crude distillation, the relative mole ratio of alkylbenzene to olefin in the downstream reactor will be substantially lower than it would otherwise be, resulting in a beneficial reduction in heavies production. As the upstream reactor is operated so as to react at least 95 mole percent of the olefin feed, unreacted olefin is typically a small portion of the effluent from the upstream alkylation reaction zone, say, less than about 1, often less than about 0.1, mole percent of the effluent. Generally less than about 60, often between about 5 and 30, weight percent of the unreacted olefin-containing compound fed to the crude distillation will be in the overhead.

The overhead may be cooled to cause condensation and then the liquid pumped to the inlet portion of the downstream alkylation reactor. A portion of the condensed liquid may be used as reflux for the lights distillation.

The crude distillation will provide at least a bottoms stream containing alkylbenzene. When using other than a flash distillation, one or more midcuts can also be taken. If no midcuts are taken, the composition of the bottoms stream will simply be the balance of the feed to the crude distillation column. If one or more midcuts are taken, the composition of the bottoms stream would differ. Usually the bottoms stream will contain at least about 80, and often at least about 90 or even 95 or more, weight percent of the alkylbenzene in the feed to the crude distillation column. The bottoms stream will also contain benzene, e.g., at least about 0.5, say, 1 to 80, weight percent of the benzene in the effluent fed to the crude distillation column. Where no midcut is taken and paraffin is present, the bottoms stream will contain paraffin, usually in an amount of at least 40 weight percent of the paraffin contained in the feed to the crude distillation column.

The inlet portion of the downstream alkylation reactor receives the overhead from the crude distillation and also receives additional olefin. The alkylation conditions for the downstream reactor may be the same or different than those for the upstream reactor but fall within the broad conditions set forth above for alkylation. The benzene fed to the downstream reactor may be solely that provided by the overhead from the crude distillation and any portion of the effluent from the upstream reactor that is not passed to the crude distillation. If desired, additional benzene can be introduced into the downstream reactor. In preferred embodiments, the additional olefin provided to the downstream reactor provides a mole ratio of benzene to olefin at least as great as that introduced into the upstream reactor.

Additional alkylation reactors may be used, either in parallel or in series to the upstream and downstream alkylation reactors. These reactors may, or may not, be provided with crude distillations between reactors as described above. For instance, at least a portion of or preferably all of the effluent from the downstream reactor may be directly passed to a finishing reactor to further react any olefin contained in the effluent. Unlike the upstream reactor, it is not essential that at least 95 mole percent of the olefin be reacted in the downstream reactor. Thus, the downstream reactor usually reacts at least about 50, most often at least about 90, mole percent of the olefin. The finishing reactor typically assures that at least about 99, preferably at least about 99.5, mole percent of the olefin provided to the downstream reactor and the finishing reactor is reacted.

At least a portion of or preferably all of the effluent from the downstream reactor is directly passed to the alkylbenzene refining system or is passed to one or more subsequent alkylation reactors with or without interstage crude distillations, and then to the alkylbenzene refining system. The alkylbenzene refining system serves to remove benzene, olefins, heavies, and, if present, paraffins, from the alkylbenzene.

In common commercial configurations, the alkylbenzene refining system or assembly comprises a distillation assembly that recovers essentially all the benzene from the alkylation effluent and provides a relatively pure benzene stream as the overhead. The bottoms stream from this distillation assembly would then be passed to a distillation assembly to separate as the overhead, paraffins and unreacted olefins, and the bottoms from this second distillation assembly would be fed to a heavies distillation assembly where the alkylbenzene product is contained in the overhead. If desired, a finishing column may be used to further purify the alkylbenzene, especially after a clay treatment to remove color formers. In this type of distillation train, the bottoms stream from the crude distillation is normally fed to the distillation assembly for separating benzene.

In further detail for purposes of illustration using a dehydrogenation product stream containing both paraffins and olefins as the source of olefins for the alkylation, the benzene distillation is generally conducted with a bottoms temperature of less than about 300° C., preferably less than about 275° C., usually between about 230° C. and 270° C., and at a pressure at which the overhead is provided of between about 5 and 300, preferably between about 35 and 70, kPa gauge. The overhead generally contains less than about 2, preferably less than about 1.5, weight percent paraffins. The benzene distillation assembly may comprise one or more distillation columns. More than one overhead may be obtained from the benzene distillation assembly. For instance, a highly pure stream may be obtained for process needs such as regenerating catalysts or sorbents, e.g., having a paraffin concentration less than about 1, preferably less than about 0.1, weight percent. A lesser purity overhead may be obtained from the benzene distillation assembly, e.g., as a side draw, for use as a recycle to the alkylation reaction.

Each column used in the benzene distillation assembly may contain any convenient packing or distillation trays, but most often trays such as sieve and bubble trays, are used. Often the assembly provides at least about 5, say 6 to 70, and preferably 20 to 50, theoretical distillation plates. The reflux ratio is often in the range of about 2:1 to 1:10, preferably about 1.5:1 to 1:5. The bottoms stream from the benzene distillation generally contains less than about 1000 ppmw, preferably less than about 50 ppmw, and sometimes less than about 5 ppmw, benzene. The benzene distillation may occur in a single column or two or more distinct columns may be used. For instance, a stripping column may be used to remove a portion, e.g., 20 to 50 percent, of the benzene and then the bottoms from the stripping column would be subjected to rectification in a subsequent column to obtain the desired separation.

The paraffin distillation is generally conducted with a bottoms temperature of less than about 300° C., preferably less than about 275° C., usually between about 250° C. and 275° C., and at a pressure at which overhead is provided of between about 5 and 110, preferably between about 10 and 50, kPa absolute. The column may contain any convenient packing or distillation trays, but most often sieve trays are used. Often the paraffins distillation assembly provides at least about 5, say 7 to 20, theoretical distillation plates. The reflux ratio is often in the range of about 3:1 to 1:10, preferably about 1:1 to 1:3. The bottoms stream from the paraffins distillation generally contains less than about 5000, preferably less than about 500, parts by million by weight (ppmw) paraffins and preferably less than about 10, often less than about 1, ppmw benzene. The paraffins distillation may occur in a single column or two or more distinct columns may be used.

The heavy alkylate distillation is generally conducted with a bottoms temperature of less than about 300° C., preferably less than about 275° C., usually between about 250° C. and 275° C., and at a pressure of between about 0.5 and 30, preferably between about 1 and 5, kPa absolute. The column may contain any convenient packing or distillation trays, but most often structured packing is used. Often the heavy alkylate distillation assembly provides at least about 5, say 10 to 30, and preferably 10 to 20, theoretical distillation plates. The reflux ratio is often in the range of about 2:1 to 1:5, preferably about 0.2:1 to 1:1. The overhead from the heavy alkylate distillation generally contains less than about 1000, preferably less than about 100 ppmw, and sometimes less than about 50 ppmw, total heavies.

The alkylbenzene refining system may contain additional distillation zones, e.g., to recover additional alkylbenzene from heavies.

The crude distillation may be effected in a stand-alone vessel or may be effected in a portion of the benzene column for refining the alkylation product. Where three or more alkylation reactors are used and more than one inter-reactor crude distillation is desired, the crude distillations may be conducted in the same or different vessels. For instance, the effluents from an upstream reactor and an immediate subsequent reactor may be passed to the same crude distillation zone with a portion of the overhead being passed to the immediate subsequent reactor and the remaining portion being passed to a third reactor that is downstream of the immediately subsequent reactor.

The invention will be further illustrated by reference to the drawings, which are not in limitation of the scope of the invention.

The drawings and description thereto are for purposes of illustration of the invention and are not in limitation thereof.

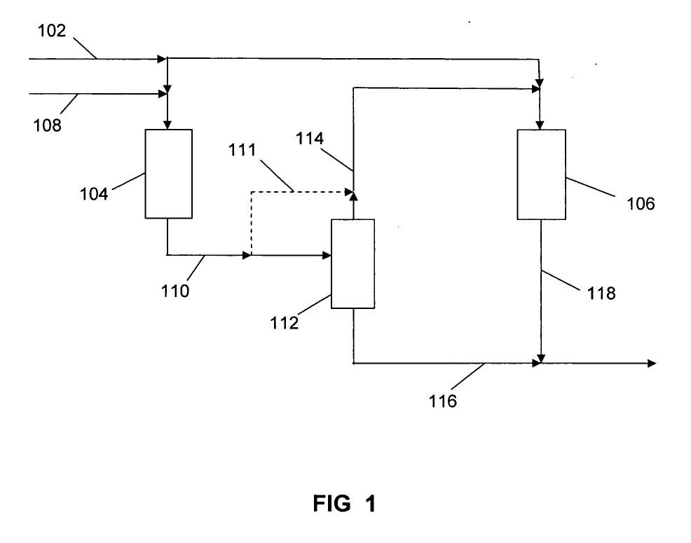

With reference to FIG. 1, an apparatus is schematically depicted for alkylation of benzene with olefin-containing aliphatic compound. For purposes of discussion, the olefin-containing compound is predominantly C₁₀ to C₁₃ normal mono-olefin and is derived from a paraffin dehydrogenation process and thus the olefin feedstock contains normal paraffin of the same or similar carbon numbers and boiling points. As shown, olefin feedstock is introduced via line 102 and a portion is directed to reactor 104 and the remaining portion is directed to reactor 106. Benzene is passed via line 108 to reactor 104. Reactor 104 is an upstream reactor, and reactor 106 is a downstream reactor. Both reactors contain a fixed bed of solid alkylation catalyst in an amount sufficient to provide a reaction effluent in which at least 95 mole percent of the olefin fed to the reactor has been reacted.

The reaction effluent from reactor 104 is directed via line 110 to flash tank 112. In the broader aspects of the invention, it is not essential that the entire effluent stream be directed to flash tank 112. A portion of the effluent may by-pass flash tank 112 via line 111. In flash tank 112, a substantial amount of the benzene contained in the effluent vaporizes as well as some of the alkylbenzene and paraffins. The heat required for vaporization cools the fluid. As shown in this embodiment, no additional heat is provided to flash tank 112 and thus a significant amount of the benzene will remain in the liquid phase. A vaporous overhead is withdrawn from flash tank 112 via line 114 and passed to the inlet portion of reactor 106. The overhead is cooled to convert the overhead to liquid and pumped into reactor 106. The condenser and pump are not shown. Flash tank 112 can be provided with a demister to minimize liquid carryover. However, since a liquid feed to reactor 106 is preferable, the use of a demister is not usually essential. The liquid phase bottoms in flash tank 112 contain alkylbenzene as well as some benzene, paraffin and unreacted olefin and exit via line 116 to be directed to an alkylbenzene refining system.

The overhead from flash tank 112 and additional olefin feedstock serve to provide the benzene and olefin for reaction in reactor 106. The reaction effluent is withdrawn from reactor 106 via line 118 to be directed to the alkylbenzene refining system.

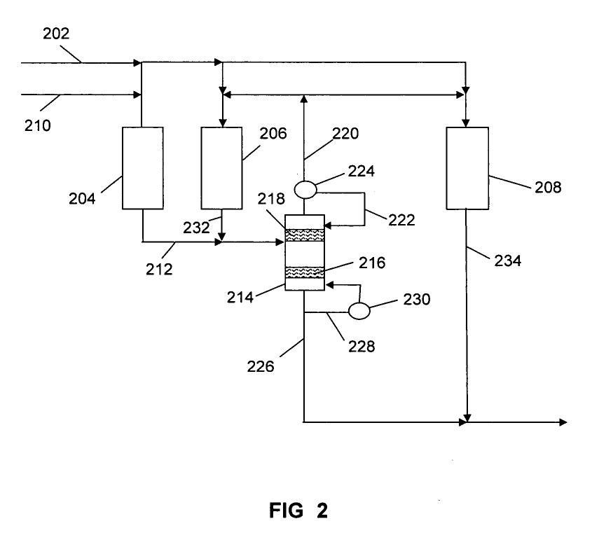

FIG. 2 depicts an apparatus in which three reactors are used. Olefin feedstock is provided via line 202 and a portion is directed to each of reactors 204, 206 and 208. The reactors contain solid catalyst as described with reference to FIG. 1. In this apparatus, each of reactors 204 and 206 serve as upstream reactors, and each of reactors 206 and 208 serve as downstream reactors. Benzene is provided to reactor 204 via line 210.

The reaction effluent from reactor 204 is passed via line 212 to distillation column 214, which contains two sieve trays 216 and 218. Overhead is withdrawn from the top of column 214 via line 220 and condensed in condenser 224. A portion of the condensate is passed to the inlet portion of reactor 206, another portion is passed to the inlet portion of reactor 208, and the last portion is recycled via line 222 to column 214 as reflux. The bottoms are withdrawn from column 214 via line 226. A portion of the bottoms stream in line 226 is withdrawn via line 228 and heated in reboiler 230 to provide additional heat to effect the distillation. The remainder of the bottoms stream is passed to the alkylbenzene refining system. The overhead is rich in benzene and contains little alkylbenzene while the bottoms contain most of the alkylbenzene fed to column 214. As compared to the flash distillation of FIG. 1, the use of a trayed column serves to improve the separation of benzene from alkylbenzene and thus, as compared to the use of a flash distillation, more of the benzene is recovered in the overhead.

The reaction effluent from reactor 206 is passed via line 232 to line 212. Thus the reactor effluents from reactors 204 and 206 are combined to provide a distillation feed to column 214.

The effluent from reactor 208 is passed via line 234 for introduction into the alkylbenzene refining system with the bottoms stream from column 214.

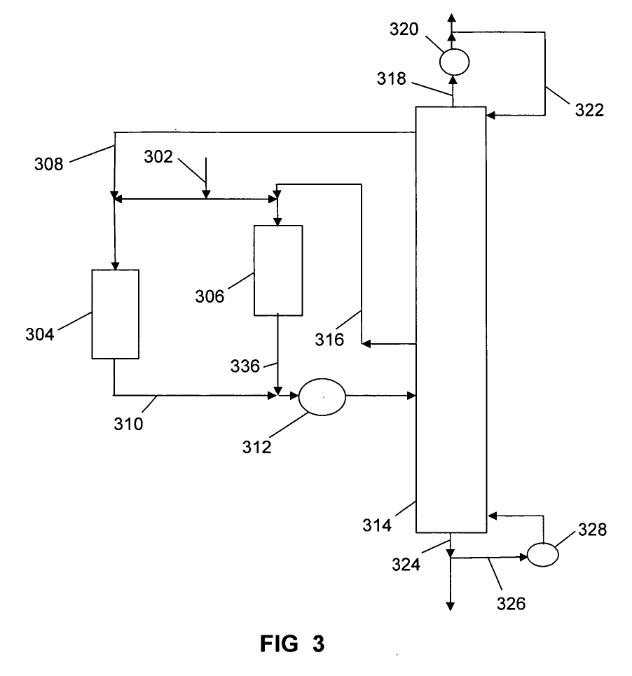

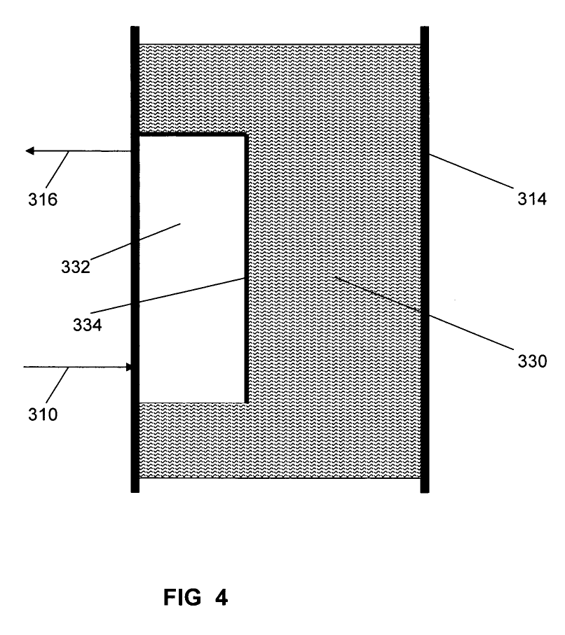

With reference to FIG. 3, the inter-reactor distillation is effected in a portion of a benzene column of an alkylbenzene refining system. The segment of the benzene refining column containing the integrated distillation is further illustrated in FIG. 4.

Olefin feedstock is introduced via line 302 with a portion directed to reactor 304 and the remainder directed to reactor 306. Reactors 304 and 306 contain catalyst as described in connection with FIG. 1 and each provides a reaction effluent. Benzene is provided to reactor 304 via line 308. Reaction effluent is withdrawn from reactor 304 via line 310 and is heated in heater 312. The heated effluent is then introduced into benzene column 314. Turning now to FIG. 4, benzene column 314 contains structured packing 330 except for flash zone 332, which is defined by walls 334. The heated distillation feed from line 310 enters flash zone 332 and due to the lower pressure in benzene column 314, a vapor phase is generated that is withdrawn via line 316. The remaining liquid phase passes down into the structured packing of column 314 for separation of benzene from the alkylbenzene.

Returning to FIG. 3, the vapor phase withdrawn from flash zone 332 is condensed and pumped into reactor 306. The reaction effluent from reactor 306 is passed via line 336 to line 310 and the combined streams are heated in heater 312 and form the distillation feed.

As shown, benzene distillation column 314 is depicted as providing two top streams. A highly purified benzene product is obtained as overhead and is withdrawn via line 318 and condensed in condenser 320. A portion of the condensed stream is taken from line 318 and recycled as reflux via line 322. The bottoms in benzene column 314, which contains alkylbenzene, paraffins and virtually no benzene, is withdrawn via line 324. A portion of the bottoms is passed via line 326, through reboiler 328 to the bottom of column 314 to provide heat for effecting the distillation.

1. A process for alkylating benzene with aliphatic mono-olefin of 11 to 19 carbon atoms to produce an unbranched alkylbenzene comprising:
a. co-currently passing a mixture of benzene and aliphatic mono-olefin having 11 to 19 carbon atoms in a molar ratio of benzene to aliphatic mono-olefin of from about 6:1 to 50:1 to an upstream alkylation zone comprising solid alkylation catalyst under liquid phase alkylation conditions to produce an upstream effluent comprising unbranched alkylbenzene and benzene wherein at least about 95 mole percent of the aliphatic mono-olefin passed to the upstream alkylation zone is reacted therein;
b. distilling a distillation feed comprising at least a portion of the upstream effluent to provide at least a first overhead and a first bottoms, stream, the first overhead comprising between about 20 and 98 weight percent of the benzene contained in the distillation feed, and the first bottoms stream comprising at least about 80 weight percent of the unbranched alkylbenzene contained in the distillation feed; and
c. passing at least a portion of the first overhead and additional aliphatic mono-olefin to a downstream alkylation zone, the downstream alkylation zone comprising solid alkylation catalyst and being under liquid phase alkylation conditions to produce unbranched alkylbenzene in the downstream effluent, and having a reduced heavies production.

2. The process of claim 1 wherein, at least about 98 mole percent of the aliphatic mono-olefin passed to the upstream alkylation zone is reacted in the upstream alkylation zone.

3. The process of claim 1 wherein the distillation feed contains between about 20 and 100 weight percent of the upstream effluent.

4. The process of claim 1 wherein the first overhead contains between about 50 and 95 weight percent of the benzene in the distillation feed.

5. The process of claim 1 wherein the first bottoms stream contains at least about 90 weight percent of the unbranched alkylbenzene in the distillation feed.

6. The process of claim 1 wherein the first bottoms stream and the downstream effluent are distilled to provide a second overhead comprising benzene and a second bottoms stream comprising unbranched alkylbenzene and less than 50 parts per million by weight benzene.

7. The process of claim 1 wherein the aliphatic mono-olefin is in admixture with paraffins of the same boiling range, the upstream effluent comprises paraffins, and the first overhead contains less than about 60 weight percent of the paraffins in the distillation feed.

8. The process of claim 7 wherein the upstream alkylation zone is at a zone pressure, and the distillation of step b is at a lower pressure than the zone pressure and at a pressure between about 80 and 250 kPa absolute.

9. The process of claim 8 wherein the upstream effluent is at an effluent pressure and the pressure for the distillation of step b is sufficiently lower than the effluent pressure that at least about 50 percent of the benzene in the distillation feed is vaporized.

10. The process of claim 8 wherein heat is provided to effect the distillation of step b in an amount of less than about 40 kilocalories per kilogram of distillation feed.

11. The process of claim 10 wherein the distillation of step b uses less than about 2 theoretical distillation plates.

12. The process of claim 8 wherein the distillation of step b is a flash distillation.

13. The process of claim 1 wherein at least a portion of the downstream effluent is passed to a further downstream alkylation zone comprising solid alkylation catalyst under liquid phase alkylation conditions to produce a further downstream effluent comprising unbranched alkylbenzene.

14. The process of claim 13 wherein at least about 95 mole percent of the aliphatic mono-olefin provided to the downstream alkylation zone is reacted in the downstream alkylation zone, and at least 99.5 mole percent of the aliphatic mono-olefin provided to the downstream alkylation zone is reacted in the downstream alkylation zone and the further downstream alkylation zone.

15. The process of claim 1 wherein the distillation feed contains at least a portion of the downstream effluent, a portion of the first overhead is passed to the downstream alkylation zone and another portion of the first overhead is passed to a further downstream alkylation zone, and additional aliphatic mono-olefin is passed to the further downstream alkylation zone, the further downstream alkylation zone comprising solid alkylation catalyst under liquid phase alkylation conditions to produce a further downstream effluent comprising unbranched alkylbenzene.

16. The process of claim 1 wherein the upstream alkylation zone is at a zone pressure and the distillation of step b is at a lower pressure than the zone pressure.

17. The process of claim 1 wherein the molar ratio of benzene to aliphatic mono-olefin is at least about 10:1.

18. An apparatus for alkylating benzene with aliphatic mono-olefin comprising:
a. an upstream alkylation reactor having (i) a first inlet portion in fluid communication with a supply of aliphatic mono-olefin and a supply of benzene and (ii) a first outlet portion, said upstream alkylation reactor having a chamber, said chamber being such that fluid passing between said first inlet portion and said first outlet portion passes through said chamber, said chamber being adequate to contain solid alkylation catalyst in an amount sufficient to react at least 95 mole percent of the aliphatic mono-olefin being supplied to said chamber;
b. a first distillation column having a first inlet in fluid communication with said first outlet portion, a first overhead outlet, and a first bottoms stream outlet, said first distillation column having less than 5 theoretical distillation plates; and
c. a downstream alkylation reactor having (i) a second inlet portion in fluid communication with a supply of aliphatic mono-olefin and with said first overhead outlet and (ii) a second outlet portion.

19. The apparatus of claim 18 wherein said first distillation column is a flash distillation column.

20. The apparatus of claim 18 further comprising a second distillation column having (i) a second inlet in fluid communication with said first bottoms stream outlet and said second outlet portion, (ii) a second overhead outlet in fluid communication with said first inlet portion, and (iii) a second bottoms stream outlet.

21. The apparatus of claim 20 wherein said first distillation column is integral with said second distillation column.
